(19) United States
(12) Patent Application Publication
(10) Pub. No.: US 2023/0286218 A1
(43) Pub. Date: Sep. 14, 2023

(54) PROTECTIVE PAD, METHODS OF MANUFACTURE THEREOF, AND RELATED SYSTEMS

(71) Applicant: Alexander Barton, Scarborough (AU)

(72) Inventor: Alexander Barton, Scarborough (AU)

(21) Appl. No.: 18/019,810

(22) PCT Filed: Apr. 16, 2021
(86) PCT No.: PCT/AU2021/050341

§ 371 Date: Feb. 5, 2023

(30) Foreign Application Priority Data
Jul. 5, 2020 (AU) 2020902298

(51) Int. Cl. B29C 64/393; A41D 13/015; A41D 13/05; B29C 64/118

(52) U.S. Cl. CPC B29C 64/393; A41D 13/015; A41D 13/0575; B29C 64/118; B33Y 50/02

(57) ABSTRACT

The present disclosure provides a core protective pad formed of rigid or semi-rigid filaments having been fused together by melting, thereby eliminating the risk of skin injury by splintered fibres. The pad is easy to manufacture by 3D printing, allowing for custom built protective pads to be provided for various areas of an individual athlete's body. Thus, also provided by the present disclosure is a method of manufacture of a protective pad including the 3D printing of the pad to custom specifications and subsequently applying heat to bond the fibres together. Related systems for implementing the method are also provided.

### CROSS-REFERENCE TO RELATED APPLICATIONS

The present application claims the benefit of Australian provisional application no. 2020902298 filed 5 Jul. 2020.

### FIELD OF INVENTION

The present disclosure relates generally to the field of protective sportswear. More specifically, the present disclosure provides a protective pad for protecting a target body area, the pad being formed from melted 3D printed filament material, and a method of manufacturing such pads to custom specifications.

### BACKGROUND

Competitive, hard contact sports command an enormous following and market value, while posing a serious risk of injury to participating players every game. Despite this, the protective gear readily available to such athletes is relatively crude, with few personalized options available on the market and an emphasis on mass producing products at a low cost at the expense of material quality.

Shin pads, shoulder pads, and helmets are the most widely marketed sports protection wear, however even in combination these solutions leave many areas of an athlete's body vulnerable. Furthermore, they are usually only available in preset sizes, rather than being constructed based on the contours of an individual athlete's body, which can vary greatly even on the same body area.

Taking shin pads as an example, these only protect the fibula and tibia bones from frontal impacts. Many sports injuries occur from low and high impact tackles and lateral and medial impacts to the legs and ankles, as well as from behind where the all-important Achilles tendon is located. There is also very limited protection for the metatarsal and phalange toe bones, and often being trodden or stamped on by football studs or from hard ball contact, which can frequently result in damaged muscle tissues, tendon and ligament damage and sometimes even broken or fractured bones.

Such gear usually relies on tightened straps and/or sports tape to hold them in place securely, and they are often manufactured from inferior materials such as cheap plastics, cloths, foams, leathers, and gels which have a limited life span. Some attempts have been made to produce custom-fitted protective wear, however these are manufactured by layers of interlocked fibers such as carbon fibers mixed with resin. These fibers can easily splinter, posing risks of skin injuries from broken fiber splinters. Additionally, they require expensive overseas industrial machines to produce, which can take weeks if not months for the end product to arrive.

It is within this context that the present invention is provided.

### SUMMARY

It is desirable to protect a variety of locations on the athletes/sports players' legs, ankles, toes, feet, hands, fingers, wrists, arms, shoulders, ribs and spine which can potentially be injured from low and high-speed impacts, from football boot studs, physical contact and contact from hard balls. Furthermore, it would also be desirable to have a device which is energy absorbing so that any change of direction caused by the impact is reduced, and also one that can be reinforced in certain areas with a combination of impact-resistant materials to reduce a higher force/impact during sporting activities and help reduce possible injuries.

Thus the present disclosure solves the forgoing problems by the provision of an energy-absorbing core protective pad formed of rigid or semi-rigid filaments having been fused together by melting, thereby reducing the risk of skin injury by splintered fibres. The pad is able to be manufactured by 3D printing, allowing for custom built protective pads to be provided for various areas of an individual athlete's body. Thus, also provided by the present disclosure is a method of manufacture of a protective pad including the 3D printing of the pad to custom specifications and subsequently applying heat to bond the fibres together. Related systems for implementing the method are also provided.

Thus, according to a first aspect of the present disclosure, there is provided a method of manufacturing a protective pad, the method comprising: receiving, by a processor, one or more body parameters for a target area of a body; based on the one or more body parameters, constructing a 3-dimensional model of a protective pad for the target area; receiving, by a 3D printer, the 3-dimensional model and printing a protective pad according to the 3-dimensional model from one or more rigid or semi-rigid filament materials; and applying, by a heating element, a heat above the melting temperature of the one or more rigid or semi rigid filament materials to the protective pad to fuse the filaments together.

In some embodiments, the method further comprises: cutting to a sheet of a second material according to the shape and dimensions of the protective pad, such as an identical shape with approximately 10% overlap; encapsulating the protective pad in the cut-out of the second material to form an outer layer on the protective pad; and securing the outer layer to the protective pad.

Securing the outer layer to the protective pad may comprise applying an adhesive between the outer layer and the protective pad and applying compression to the encapsulated protective pad until the adhesive has set.

Alternatively, securing the outer layer to the protective pad comprises applying stitches to the outer layer.

The method may further comprise, after securing the outer layer to the protective pad, applying a heat press to the encapsulated protective pad.

It should be noted that the outer layer can be formed of any one, or a combination of any of: polymer rubber, polymer foam material, neoprene rubber, EVA foam, synthetic rubber, latex rubbers, styrene butadiene (SBR) and natural gum rubbers.

In some embodiments, instead of having an outer layer applied thereto, the protective pad is placed inside a material pocket pouch on the inside of a material sleeve made from one of from a combination of EVA foam, synthetic rubber, latex, natural gum rubbers and/or neoprene rubber.

Alternatively, in other embodiments, the protective pad, housed within the aforementioned outer layer or pouch, is secured on an inner surface of a piece of clothing so as to be positioned adjacent to the target body area when the piece of clothing is worn.

The heating element can be a component of the 3D printer that carries out the construction of the protective pad core. For example, the heating element can be a heated printhead extruder or heated nozzle.

Furthermore, the one or more body parameters of the target area may be acquired by a scanning operation, performed by a scanning module, on the target area of the body of an individual. The scanning module may generate point cloud data file containing the one or more body parameters. The one or more body parameters may include one or more dimensions and one or more 3-dimensional contours for the target area.

In some embodiments, the scanning module is a handheld device. In other embodiments the scanning module is a booth.

The method may further comprise converting the data generated by the scan for compatibility with a computer aided design, CAD, program.

In some embodiments, the step of constructing a 3-dimensional model of a protective pad for the target area comprises operations by the processor, including: constructing a 3-dimensional model of the target body area; constructing a shape having a first inner surface with contours designed to match the contours of the target body area and an outer surface having contours defining the thickness of the protective pad based on a desired level of impact protection for each point.

The filament material for constructing the internal protective pad may be formed of one or more of: Kevlar filaments, Onyx filaments, carbon fibre filaments, nylon filaments, and Polymer thermoplastic filaments.

According to a second aspect of the present disclosure, there is provided a protective pad formed according to the methods described above.

According to a third aspect of the present disclosure, there is provided a 3D-printed protective sports pad shaped to fit a target body area of an individual, the protective sports pad being formed of a melted rigid or semi-rigid filament material.

The melted filament material may be formed of one or more of: Kevlar filament, Onyx filament, carbon fibre filament, nylon filament, and Polymer thermoplastic filament.

In one embodiment, the melted rigid or semi-rigid filament material is encapsulated in an outer layer. The outer layer may be secured to the melted filament material by stitching or adhesive. The outer layer may be formed of one or more of: polymer rubber, polymer foam material, neoprene rubber, EVA foam, synthetic rubber, elastomers (TPE, TPR-thermoplastic rubbers), natural latex rubber, styrene butadiene (SBR) and natural gum rubbers.

In another embodiment, the melted rigid or semi-rigid filament material is encapsulated in a soft flexible pocket pouch. The soft pouch may be formed of one or more of: polymer rubber, polymer foam material, neoprene rubber, EVA foam, synthetic rubber, natural latex rubber, styrene butadiene (SBR) and natural gum rubbers.

In another embodiment, the protective pad is secured to an inner surface of a piece of clothing by adhesive or stitching.

### BRIEF DESCRIPTION OF THE DRAWINGS

Various embodiments of the disclosure are disclosed in the following detailed description and accompanying drawings.

FIG. 1 illustrates a perspective view of an example configuration of the protective pad of the present disclosure having been manufactured to protect the target body area of the fibula and tibia bones and surrounding tissue.

FIG. 2 illustrates an exploded front perspective view of the same example configuration of the protective pad and the inner and outer external surfaces of the present disclosure having been manufactured to protect the target body area of the fibula and tibia bones and surrounding tissue.

FIG. 3 illustrates a perspective view of the same example configuration of the protective pad of the present disclosure having been manufactured to protect the target body area of the fibula and tibia bones and surrounding tissue and inserted inside a sleeve or “pocket pouch” on the inside of a material sleeve to be worn around an athlete's lower leg.

FIG. 4 illustrates a perspective view of the example configuration of the protective pad on the inside/skin side of the material of the sleeve of FIG. 3 worn on the lower leg of a user.

FIG. 5 illustrates a frontal view of an individual's body with 10 different types of protective pads referenced for protecting various target body areas equipped on each side.

FIG. 5A illustrates the same individual viewed from the right side with the further protective pads specifically for protecting the legs, feet, hands, and finger areas referenced.

FIG. 5B illustrates the same individual viewed from the left side with the additional protective pads specifically for protecting the feet, legs, hands and finger areas referenced.

FIG. 5C illustrates a perspective view of the same individual wearing the same set of 10 different types of protective pads for protecting various target body areas.

FIG. 6 illustrates a perspective view of a football boot with 6 different types of foot protective pads secured thereto.

FIG. 7 illustrates a perspective view of an athlete sports shoe with 6 different types of foot protective pads secured thereto.

FIG. 8 illustrates a set of three different protective pads for protecting separate target areas of the lower leg and a sleeve having three separate “pocket pouches” for holding the respective pad in place over the respective target body areas. Once inserted the protective pads are stitched on the inside of the material sleeve to cover the Achilles, soleus calf muscle, and gastrocnemius muscle areas.

FIG. 9 illustrates the protective pads and sleeve of FIG. 8 having been stitched together and placed over the lower leg of a user.

FIG. 10 illustrates a flow diagram of an example set of steps in a method for manufacturing one or more protective pads and garments incorporating the protective pads according to the present disclosure.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the disclosure, as set forth in the claims.

### DETAILED DESCRIPTION

The following is a detailed description of exemplary embodiments to illustrate the principles of the disclosure. The embodiments are provided to illustrate aspects of the disclosure, but the disclosure is not limited to any embodiment. The scope of the disclosure encompasses numerous alternatives, modifications and equivalent; it is limited only by the claims.

Numerous specific details are set forth in the following description in order to provide a thorough understanding of the disclosure. However, the disclosure may be practiced according to the claims without some or all of these specific details. For the purpose of clarity, technical material that is known in the technical fields related to the disclosure has not been described in detail so that the disclosure is not unnecessarily obscured.

The terminology used herein is for the purpose of describing particular embodiments only and is not intended to be limiting of the disclosure. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present disclosure relates to devices and the method for producing the devices. These devices are impact-resistant and energy absorbing customised sports protection shields, e.g. personalised athletic protection devices. The devices are manufactured by a three-dimensional (3D) printing machines which lay down successive layers of build material onto a print bed, as is well known in the art, to produce a precise custom-fitted protection shield to fit a target area of an individual athlete's body.

The devices are constructed from impact-resistant and energy absorbing three-dimensional printed materials to reduce injuries by dissipating forces from high and low collisions, and can be designed for any body part of a sports athlete's body so as to protect a variety of locations on the athletes/sports players' legs, ankles, toes, feet, hands, fingers, wrists, arms, shoulders, ribs and spine which can potentially be injured from low and high-speed impacts, from football boot studs, physical contact and contact from hard balls. The feature of the devices being energy absorbing has the resultant effect that impacts on athletes equipped with the devices does not change their direction, and also one that can be reinforced in certain areas with a combination of impact-resistant materials to reduce a higher force/impact during sporting activities and help reduce possible injuries.

Thus the present disclosure solves the forgoing problems by the provision of an energy-absorbing core protective pad formed of rigid or semi-rigid filaments having been fused together by melting, thereby eliminating the risk of skin injury by splintered fibres. The pad is easy to manufacture by 3D printing, allowing for custom built protective pads to be provided for various areas of an individual athlete's body. Thus, also provided by the present disclosure is a method of manufacture of a protective pad including the 3D printing of the pad to custom specifications and subsequently applying heat to bond the fibres together.

A core aspect of the disclosed devices/protection pads is the ease and customisability of their manufacture. As they are constructed from filament material based on three dimensional models, usually in point cloud data format, they can be 3D printed to custom specifications cheaply and in a short amount of time. Subsequent to printing, the filaments are bonded together by applying a melt, thus preventing any potential fibre splintering and reducing the risk of harm to athletes equipped with the pads. Advantageously, subsequent to construction, the pads can be encapsulated in a soft outer layer or pouch for increased durability and comfort. Alternatively, the pads can even be sewn into items of sports clothing for convenience.

As the method of manufacture is core to the disclosure, it will be explained in detail before illustrating various shapes the pads can take to be applied to different parts of an athlete's body.

The method comprises, in its broadest form, receiving one or more body parameters such as for example the dimensions and three dimensional contours of a target body area that the protective pad being manufactured will be applied to.

The processor receiving the one or more body parameters may be a computer connected to a 3D printer, for example, however other configurations could be used. It could even be possible for data from scans to be sent directly to a 3D printer in a format that can be immediately understood and processed by the printer. Those of skill in the art reading the present disclosure will understand that the exact configuration of processors used is not limiting, and that the method should and can be applied in the most suitable way based on the means available. In some configurations the body parameters may need to be converted into a Computer Aided Design (CAD) program format before being processed further. The method may further comprise converting the data generated by the scan for compatibility with a computer aided design, CAD, program. For example a point cloud data representation of the target body area may be converted for compatibility with CAD software programs such as AutoCAD, Revit, and ArchiCAD.

In the present example, once the body parameters are received by the processor a next step is to construct a 3-dimensional model of a protective pad for the target area of the body using the negative space surrounding the contours of the target body area. Methods for carrying out this step may use CAD methods.

Once the 3-dimensional model has been constructed it is forwarded as instructions to a 3D printer which constructs the pad layer by layer. Many different types of 3D printer are suitable for carrying out this step and their operations are well known to the skilled person. The material used for the construction is a rigid or semi-rigid filament material.

Examples of suitable filament materials that are impact resistant and energy absorbing are: Kevlar filament, Onyx filament, carbon fibre filament, nylon filament, and Polymer thermoplastic filament.

Polymer thermoplastics are the most cost efficient of these and include materials such as aramids PI Aromatic Polyamide, Polyetherketoneketone (PEKK), Polyphenylene Sulfide (PPS), high-density polyethylene (HDPE), low-density polyethylene (LDPE), polycarbonates (PC), polylactic acid (PLA), cellulosics (CA, CAB, CAP or CN), polycarbonate (PC), polyacetals (POM), Polyethylene terephthalate (PBT) & Polyethylene terephthalate (PET) polyesters, polyphenylene Oxide (PPO), high impact polystyrene (HIPS), styrene Acrylonitrile (SAN) & Acrylonitrile Styrene Acrylate (ASA), epoxies (EP), unsaturated Polyester (UP), Melamines/Ure (MF, UF), nylons (PA) polyamide nylons (PA) and other aramid fibres.

Finally, and importantly, the core process of manufacture includes applying a high temperature, at or above the melting temperature of the filament material used, in order to melt the fibres of the pad together. This can be achieved by any suitable heating process, including the application of heat by the printhead of the 3D printer itself. Advantageously this process prevents fibres from splintering from the pad during an impact, reducing the risk of skin injuries to athletes wearing the pads.

Subsequently, the pads can be adapted for sportswear in a number of different ways.

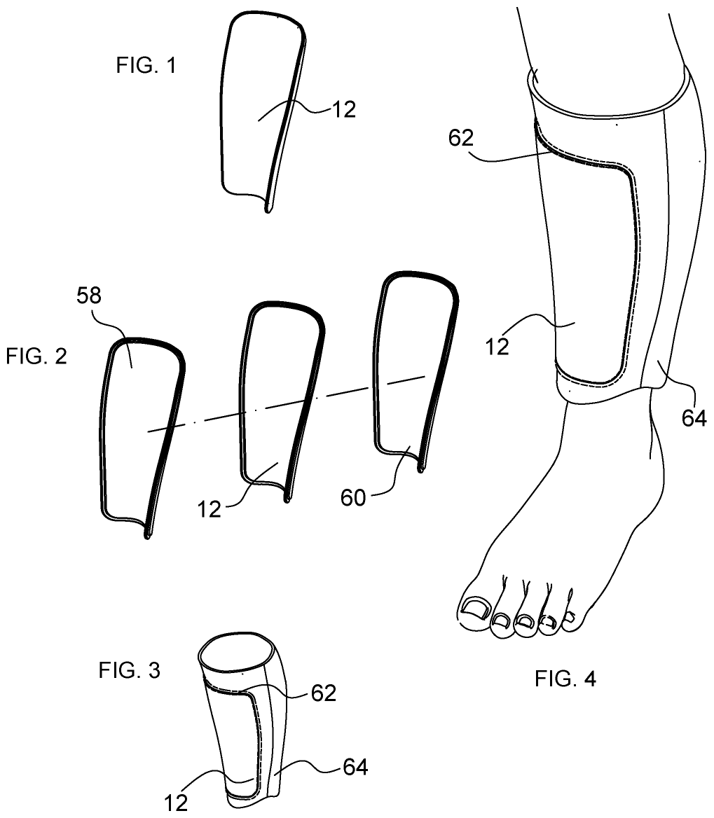

In a first embodiment, the protective pads that are 3D printed are used as internal components of a layered pad. See for example FIGS. 1 and 2.

A sheet of a second material is cut according to the shape and dimensions of the protective pad and wrapped around it to form a capsule with an outer layer. For example, the second material may be cut with a 10% overlap to wrap around the inner component. Multiple pieces of second material can be cut to form an outer shell around the inner protective pad. The outer layer material should be waterproof, soft, flexible, and wear-resistant. Examples of suitable materials for forming the outer layer include but are not limited to polymer rubber, polymer foam material, neoprene rubber, EVA foam, synthetic rubber, elastomers (TPE, TPR-thermoplastic rubbers), natural latex rubber, styrene butadiene (SBR) and natural gum rubbers. Combinations of these and other materials can also be used. Inclusion of the outer layer increases wear resistance and comfort for the wearer.

Finally, the outer layer should be secured to the protective pad. The protective pad and the outer layer components are connected and pressed together, for example using the weight of small lead balls, and then bonded by use of an adhesive such as a strong glue or wetsuit cement. Alternatively or additionally, the outer layer can be stitched together, for example with canvas thread. Alternatively or additionally, the components may be heat pressed transferred, using a hot air wedge welder machine to permanently bond sheets of the outer layer together with the inner protective pad.

In a second embodiment of the method, instead of having an outer layer applied, the protective pad is placed inside a material pocket pouch on the inside of a material sleeve made from one of from a combination of EVA foam, rubber, spandex and/or neoprene rubber. See for example FIG. 3. The material sleeve may be elastic and designed to maintain the protective pad in place over the target body area. One advantage of having a pocket with an opening instead of the pad being sewn into the fabric completely is that the pad can easily be taken out and cleaned.

FIG. 4 shows the assembled pads and sleeve in place on the lower leg of a user.

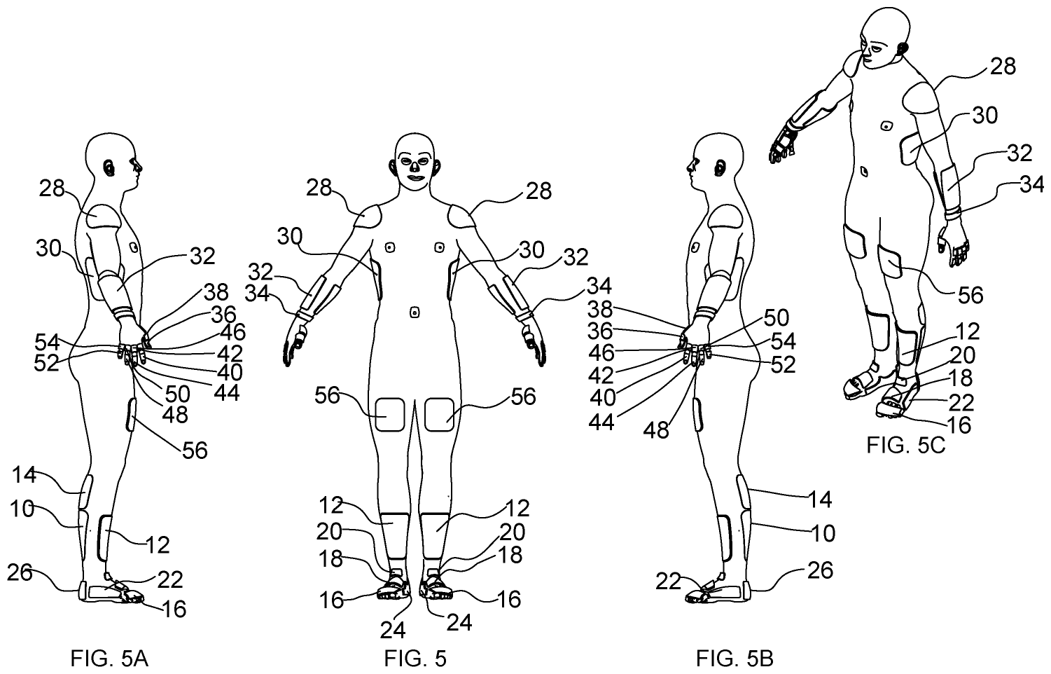

In a third embodiment of the method, the protective pad is secured on an inner surface of a piece of clothing so as to be positioned adjacent to the target body area (such as for example the body areas displayed with adjacent pads in any one of FIGS. 5, 5A, 5B, and 5C) when the piece of clothing is worn.

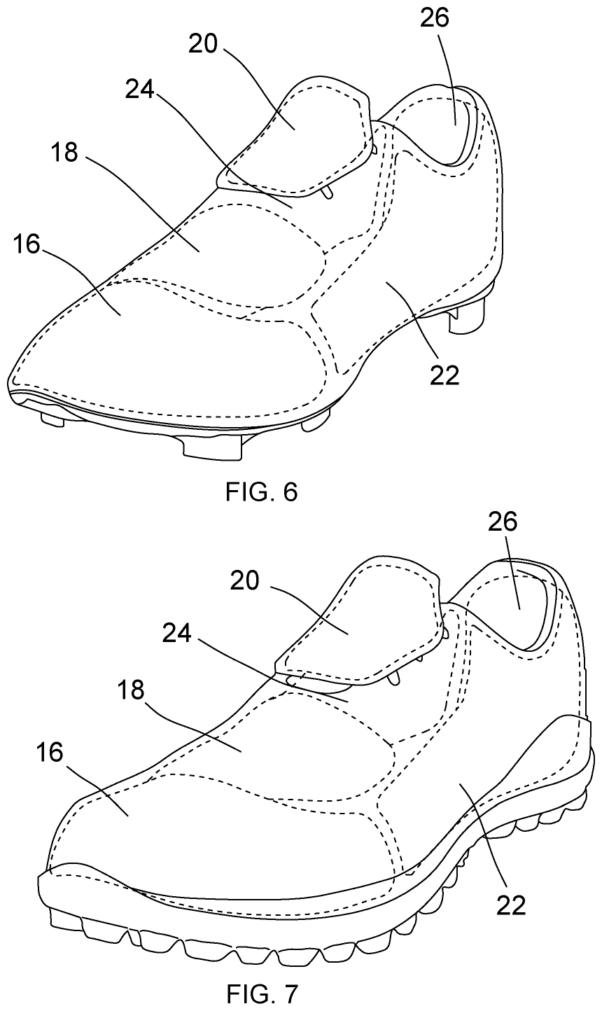

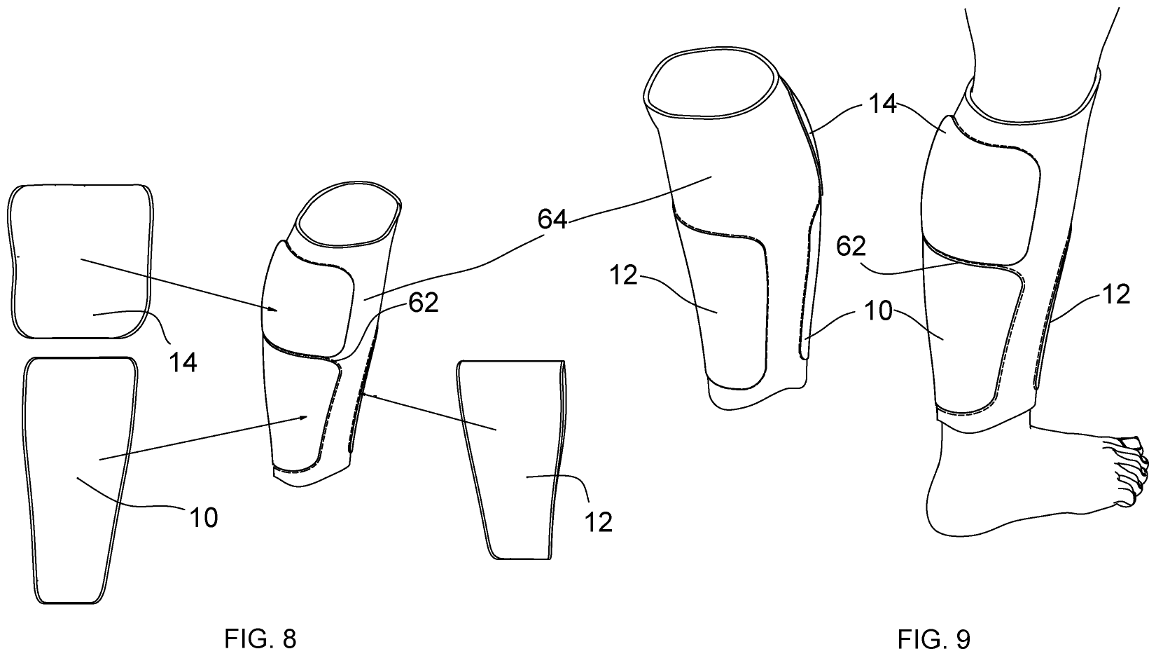

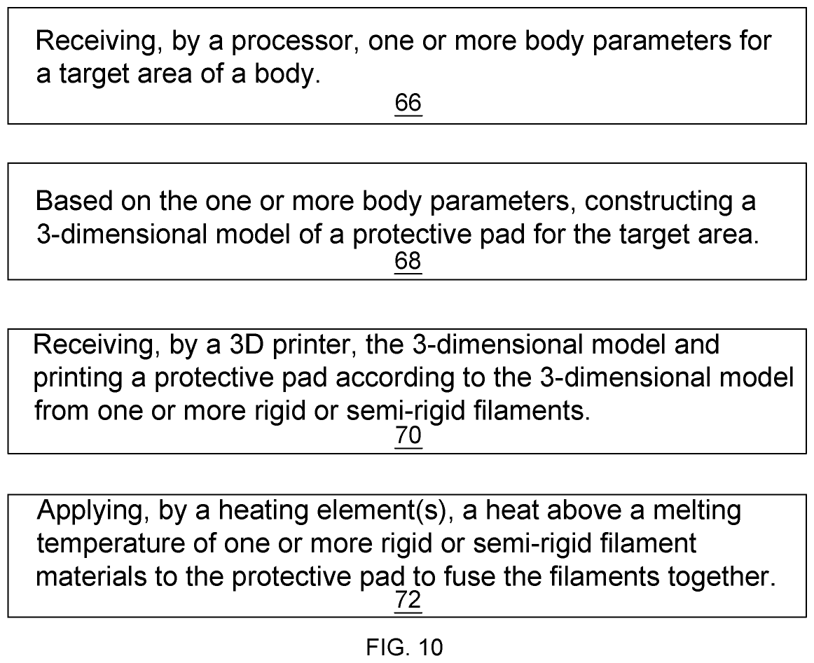

The third embodiment can also include the outer layer of the first embodiment. Thus the protective pads with or without an external capsule layer connected can be adhered, for example, inside the fabric of an athlete's sports shoes or boots to produce sports protection shoes and sports protection boots. See for example FIGS. 6 and 7. The pads are connected inside the fabric, mostly leather, with the use of a strong glue or wetsuit cement and then stitching will be applied into the fabrics and around the edges of the internal shields. Other examples of clothing the pads might be attached to include socks and gloves.

Protective gloves are a particularly useful application of the disclosed protective pad assembly, and have uses in most high impact sports including football, cricket, NFL, baseball, MMA, boxing, field hockey, lacrosse, and many others.

It is inevitable that a risk will be posed to a player's hands in any such fast-paced sport and protecting player's hands is an extremely high priority since injuries to them can cause long term damage and prevent further participation in the sport.

Thus, in one example, the protective pads of the present disclosure are sewn or otherwise stitched into various points of a sports glove to protect the hand of the wearer. These can include finger shields, knuckle shields, and larger shields covering the back of the hands and wrists. Combinations of such shields and correct placement thereof can protect all areas of the hands and wrists. The shields are small enough not to restrict movement, but absorb and spread the impact from projectiles and impacts with the ground and other players. This reduces the risk of injury and can also be used to ensure previous injuries are protected.

The method may also comprise the step of obtaining the body parameters. For example, the body parameters for an individual could be obtained based on a scan having been performed on a particular individual desiring to use the protective pad for impact protection while playing high impact sports. In this manner each pad can be custom built to fit an individual's body, thus providing better protection and comfort than a one-size-fits-all piece of equipment.

Thus the method may include a scanning operation, performed by a scanning module, on the target area of the body of an individual to produce a three-dimensional representation of an area of the athlete body such as their leg, ankle, toes, wrist, hand, fingers or feet.

The scanning module may generate point cloud data file containing the one or more body parameters. The one or more body parameters may include one or more dimensions and one or more 3-dimensional contours for the target area.

The scanning module could be a multifunctional handheld device such as a smartphone capable of determining 3D point profiles, it could be a specialised piece of equipment for determining the contours with high accuracy, or it could be a booth that an athlete enters to be scanned.

The internal device is then sketched over the three-dimensional CAD model of the body area the player wants to protect, using the negative space around the three-dimensional CAD model to produce a variety of sketches of different shapes and sizes which are then saved as an STL (stereolithography) file. The converted file is transferred to the 3D printer in any suitable way, such as using the bluetooth wireless function on the 3D printer or by saving the file to a hard drive, flash drive or portable storage device which is then inserted inside the USB port on the 3D printer.

The disclosed methods enable highly effective sports protection wear to be manufactured at low cost and at a high speed. The protective pads themselves are also unique in that they are matched to an individual's body contours and formed of melted filaments that prevent fibre splintering.

The various figures show various different example shapes that a protective pad manufactured according to the disclosed methods might take, with various perspective, exploded and transparent views included for clarity. Each of the many protective pads illustrated has been designed to protect a certain part of the human body as set out above in the description of the drawings, however it should be recognised that the actual contours and dimensions of these pads will vary according to the individual. Although many different shapes are illustrated, the examples are not limiting, and other shapes not envisioned or described here could be used to protect different body parts, or customise protection of the same body parts. For example, the shapes could be altered to protect body parts that are already injured or inflamed from high impacts from certain directions, or even altered based on the type of sport the athlete will be playing.

Unless otherwise defined, all terms (including technical terms) used herein have the same meaning as commonly understood by one having ordinary skill in the art to which this disclosure belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

Furthermore, while having been described specifically with respect to a single processor in communication with a 3D printer, it should be understood that the operations described herein may be carried out by any processor comprising a distributed element. In particular, the operations may be carried out by, but are not limited to, one or more computing environments used to implement the method such as a data center, a cloud computing environment, a dedicated hosting environment, and/or one or more other computing environments in which one or more assets used by the method re implemented; one or more computing systems or computing entities used to implement the method; one or more virtual assets used to implement the method; one or more supervisory or control systems, such as hypervisors, or other monitoring and management systems, used to monitor and control assets and/or components; one or more communications channels for sending and receiving data used to implement the method; one or more access control systems for limiting access to various components, such as firewalls and gateways; one or more traffic and/or routing systems used to direct, control, and/or buffer, data traffic to components, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the method; one or more databases used to store data; one or more internal or external services used to implement the method; one or more backend systems, such as backend servers or other hardware used to process data and implement the method; one or more software systems used to implement the method; and/or any other assets/components in which the method is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

As used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

Unless specifically stated otherwise, as would be apparent from the above discussion, it is appreciated that throughout the above description, discussions utilizing terms such as, but not limited to, “adding”, “applying”, “analyzing”, “associating”, “capturing”, “classifying”, “comparing”, “creating”, “defining”, “detecting”, “determining”, “eliminating”, “extracting”, “forwarding”, “generating”, “identifying”, “implementing”, “obtaining”, “processing”, “providing”, “receiving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present disclosure is not described with reference to any particular programming language and it is appreciated that a variety of programming languages may be used to implement the teachings of the present disclosure as described herein, and any references to a specific language or languages are provided for illustrative purposes only and for enablement of the contemplated best mode of the disclosure at the time of filing.

The present disclosure is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present disclosure is intended to be illustrative, but not limiting, of the scope of the disclosure, which is set forth in the claims below. In addition, the operations shown in the figures, or as discussed herein, are identified using a particular nomenclature for ease of description and understanding, but other nomenclature is often used in the art to identify equivalent operations.

The disclosed embodiments are illustrative, not restrictive. While specific configurations of the protective pad and associated manufacturing methods have been described in a specific manner referring to the illustrated embodiments, it is understood that the present disclosure can be applied to a wide variety of solutions which fit within the scope and spirit of the claims. There are many alternative ways of implementing the disclosure.

It is to be understood that the embodiments of the disclosure herein described are merely illustrative of the application of the principles of the disclosure. Reference herein to details of the illustrated embodiments is not intended to limit the scope of the claims, which themselves recite those features regarded as essential to the disclosure.

### APPENDIX A—REFERENCE NUMERAL LIST

10 Internal Achilles tendon and soleus calf muscle pad
12 Internal fibula and tibia bone pad
14 Internal gastrocnemius calf muscle pad
16 Internal phalange (bones) toe cap pad for the football boot and sports shoe
18 Internal metatarsal (bones) toe pad for the football boot and sports shoe
20 Internal cuneiform (ankle bones) pad for the tongue of the football boot and sports shoe
22 Internal lateral foot pad for the football boot and sports shoe
24 Internal medial foot pad for the football boot and sports shoe
26 Internal lower Achilles tendon pad for the rear of the football boot and sports shoe
28 Internal shoulder bone & shoulder muscle pad
30 Internal rib bones pad
32 Internal radius & ulna (bone) pad
34 Internal wrist pad
36 Internal thumb nail pad
38 Internal thumb knuckle pad
40 Internal index finger nail pad
42 Internal index finger knuckle pad
44 Internal middle finger nail pad
46 Internal middle finger knuckle pad
48 Internal ring finger nail pad
50 Internal ring finger knuckle pad
52 Internal pinky finger nail pad
54 Internal pinky finger knuckle pad
56 Internal quadricep muscle pad
58 Fibula and tibia bone inner external surface
60 Fibula and tibia bone outer external surface
62 Fibula and tibia bone pocket pouch
64 Fibula and tibia bone material sleeve
66 Receiving, by a processor, one or more body parameters for a target area of a body.
68 Based on the one or more body parameters, constructing a 3-dimensional model of a protective pad for the target area.
70 Receiving, by a 3D printer, the 3-dimensional model and printing a protective pad according to the 3-dimensional model from one or more rigid or semi-rigid filaments.
72 Applying, by a heating element(s), a heat above a melting temperature of one or more rigid or semi-rigid filament materials to the protective pad to fuse the filaments together.

What is claimed is:

1. A method of manufacturing a protective pad, the method comprising:
receiving, by a processor, one or more body parameters for a target area of a body;
based on the one or more body parameters, constructing a 3-dimensional model of a protective pad for the target area;
receiving, by a 3D printer, the 3-dimensional model and printing a protective pad according to the 3-dimensional model from one or more rigid and/or semi-rigid filament materials; and
applying, by one or more heating elements, a heat above the melting temperature of the one or more rigid and/or semi-rigid filament materials to the protective pad to fuse the filaments together.

2. A method of manufacturing a protective pad according to claim 1, wherein the method further comprises:
cutting to a sheet of a second material according to the shape and dimensions of the protective pad;
encapsulating the protective pad in the cut-out of the second material to form an outer layer on the protective pad; and
securing the outer layer to the protective pad.

3. A method of manufacturing a protective pad according to claim 2, wherein securing the outer layer to the protective pad comprises applying an adhesive between the outer layer and the protective pad and applying compression to the encapsulated protective pad until the adhesive has set.

4. A method of manufacturing a protective pad according to claim 2, wherein securing the outer layer to the protective pad comprises applying stitches to the outer layer.

5. A method of manufacturing a protective pad according to claim 2, wherein the method further comprises, after securing the outer layer to the protective pad, applying a heat press to the encapsulated protective pad.

6. A method of manufacturing a protective pad according to claim 2, wherein the outer layer is formed of one or more of: polymer rubber, polymer foam material, neoprene rubber, EVA foam, synthetic rubber, elastomers (TPE, TPR-thermoplastic rubbers), natural latex rubber, styrene butadiene (SBR) and natural gum rubbers.

7. A method of manufacturing a protective pad according to claim 1, wherein the protective pad is placed inside a material pocket pouch on the inside of a material sleeve made from one of from a combination of EVA foam, rubber, spandex and/or neoprene rubber.

8. A method of manufacturing a protective pad according to claim 1, wherein the protective pad is secured on an inner surface of a piece of clothing so as to be positioned adjacent to the target body area when the piece of clothing is worn.

9. A method of manufacturing a protective pad according to claim 1, wherein the heating element is a component of the 3D printer.

10. A method of manufacturing a protective pad according to claim 1, wherein the one or more body parameters of the target area are acquired by a scanning operation, performed by a scanning module, on the target area of the body of an individual.

11. A method of manufacturing a protective pad according to claim 10, wherein the scanning module generates point cloud data file containing the one or more body parameters.

12. A method of manufacturing a protective pad according to claim 10, wherein the one or more body parameters include one or more dimensions and one or more 3-dimensional contours for the target area.

13. A method of manufacturing a protective pad according to claim 10, wherein the method further comprises converting the data generated by the scan for compatibility with a computer aided design, CAD, program.

14. A method of manufacturing a protective pad according to claim 1, wherein the step of constructing a 3-dimensional model of a protective pad for the target area comprises operations by the processor, including:
constructing a 3-dimensional model of the target body area;
constructing a shape having a first inner surface with contours designed to match the contours of the target body area and an outer surface having contours defining the thickness of the protective pad based on a desired level of impact protection for each point.

15. A method of manufacturing a protective pad according to claim 1, wherein the filament material for constructing the protective pad is formed of one or more of: Kevlar filaments, Onyx filaments, carbon fibre filaments, nylon filaments, and Polymer thermoplastic filaments.

16. A protective pad formed according to the method of any one of claims 1 to 15.

17. A 3D-printed protective sports pad shaped to fit a target body area of an individual, the protective sports pad being formed of a melted rigid or semi-rigid filament material.

18. A 3D-printed protective sports pad according to claim 17, wherein the melted rigid or semi-rigid filament material is encapsulated in an outer layer.

19. A 3D-printed protective sports pad according to claim 18, wherein the outer layer is secured to the melted filament material by stitching or adhesive.

20. A 3D-printed protective sports pad according to claim 17, wherein the melted rigid or semi-rigid filament material is encapsulated in a soft pouch.

21. A 3D-printed protective sports pad according to claim 17, wherein the protective pad is secured to an inner surface of a piece of clothing by adhesive or stitching.

22. A protective glove comprising one or more protective pads formed according to the method of any one of claims 1 to 15.
